(19) United States
(12) Patent Application Publication
(10) Pub. No.: US 2024/0270301 A1
(43) Pub. Date: Aug. 15, 2024

(54) ROCKER SYSTEMS FOR STROLLERS AND OTHER WHEELED CARRIAGES

(71) Applicant: ROCK-N-STROLL LLC, Dania, FL (US)

(72) Inventors: Daniel Martin, Davie, FL (US); Marc Aptakin, Fort Lauderdale, FL (US)

(21) Appl. No.: 18/438,906

(22) Filed: Feb. 12, 2024

Related U.S. Application Data
(60) Provisional application No. 63/484,994, filed on Feb. 14, 2023.

(51) Int. Cl. B62B 9/22; F16M 13/02

(52) U.S. Cl. CPC B62B 9/22; F16M 13/022

(57) ABSTRACT

A rocker system for a wheeled carriage (such as a stroller for a child or infant) may include a first attachment device for attaching the rocker system to an object (such as a frame of a stroller or a fixed object such as a wall), a second attachment device for attaching the rocker system to a wheel, and a movement mechanism operatively connecting the first attachment device to the second attachment device. The movement mechanism causes the second attachment device to move the wheel back and forth. The movement mechanism may be removable from, and replaceable on, the first attachment device. The movement mechanism may include an actuator that moves an arm and the second attachment device. The arm may be neither extendable nor retractable.

### CROSS-REFERENCE TO RELATED APPLICATIONS

The present application claims priority to U.S. Provisional Patent Application No. 63/484,994, filed Feb. 14, 2023, which is incorporated herein by reference in its entirety.

### BACKGROUND

Small children and babies are often soothed and comforted by rocking motions. Existing rocker products are not very portable. For example, some cradles include motorized rocking systems. Some baby swings include motors for reciprocal movement of the swing. However, cradles and baby swings are bulky and unwieldy to transport. Sometimes a parent may push and pull a stroller or baby carriage to provide a rocking motion. However, pushing and pulling a stroller or baby carriage by hand may become tedious over time. U.S. Pat. No. 9,623,893 attempts to address some of these challenges by providing a motorized mechanism that attaches to a frame of a stroller and to a wheel, to rotate the wheel back and forth. However, the '893 patent includes an extendable arm assembly that has a joint between two arm sections, which may be a failure point, and it is difficult to install and remove. Embodiments of the present technology address these challenges and other challenges.

### SUMMARY

Representative embodiments of the present technology include a rocker system for a wheeled carriage (such as a stroller for a child or infant). The rocker system may include a first attachment device for attaching the rocker system to an object (such as a frame of a stroller or a fixed object such as a wall), a second attachment device for attaching the rocker system to a wheel, and a movement mechanism operatively connecting the first attachment device to the second attachment device. The movement mechanism causes the second attachment device to move the wheel back and forth. The movement mechanism may be removable from, and replaceable on, the first attachment device. The movement mechanism may include an actuator that moves an arm and the second attachment device. The arm may be neither extendable nor retractable (e.g., it may be a single unitary element).

Other features and advantages will appear hereinafter. The features described herein can be used separately or together, or in various combinations of one or more of them.

### BRIEF DESCRIPTION OF THE DRAWINGS

In the drawings, wherein the same reference number indicates the same element throughout the several views:

FIG. 1 illustrates a partially schematic perspective view of a rocker system configured in accordance with embodiments of the present technology, and attached to a stroller frame and wheel;

FIG. 2 illustrates a partially schematic side view of the rocker system shown in FIG. 1;

FIG. 3 illustrates a partially schematic top view of the rocker system shown in FIG. 1;

FIG. 4 illustrates a partially schematic perspective view of the rocker system shown in FIG. 1 separated from the frame and the wheel;

FIG. 5 illustrates a partially schematic side view of the rocker system shown in FIG. 1 separated from the frame and the wheel;

FIG. 6 illustrates a partially schematic perspective view of the rocker system shown in FIG. 1;

FIG. 7 illustrates a partially schematic exploded perspective view of the rocker system shown in FIG. 1;

FIG. 8A illustrates a partially schematic perspective view of the rocker system shown in FIG. 1 in a configuration in which a movement mechanism and a second attachment device are removed from a wheel and a first attachment device (e.g., removed from a housing mount assembly);

FIG. 8B illustrates a detailed side view of a portion of the rocker system in the configuration shown in FIG. 8A;

FIG. 8C illustrates a top view of a portion of the rocker system in the configuration shown in FIG. 8A;

FIG. 9 illustrates a partially schematic exploded perspective view of an attachment device and a portion of a movement mechanism, configured in accordance with embodiments of the present technology;

FIG. 10 illustrates a side perspective view of a rocker system configured in accordance with another embodiment of the present technology;

FIG. 11 illustrates partially schematic side perspective view of the rocker system shown in FIG. 10, in a configuration in which the movement mechanism is separated from a wall mount; and

FIG. 12 illustrates a perspective view of the wall mount shown in FIGS. 10 and 11, and configured in accordance with embodiments of the present technology.

### DETAILED DESCRIPTION

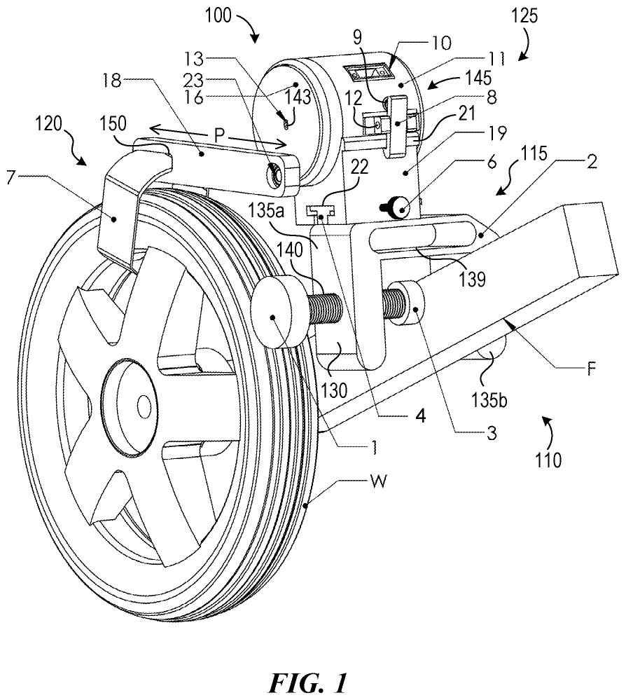

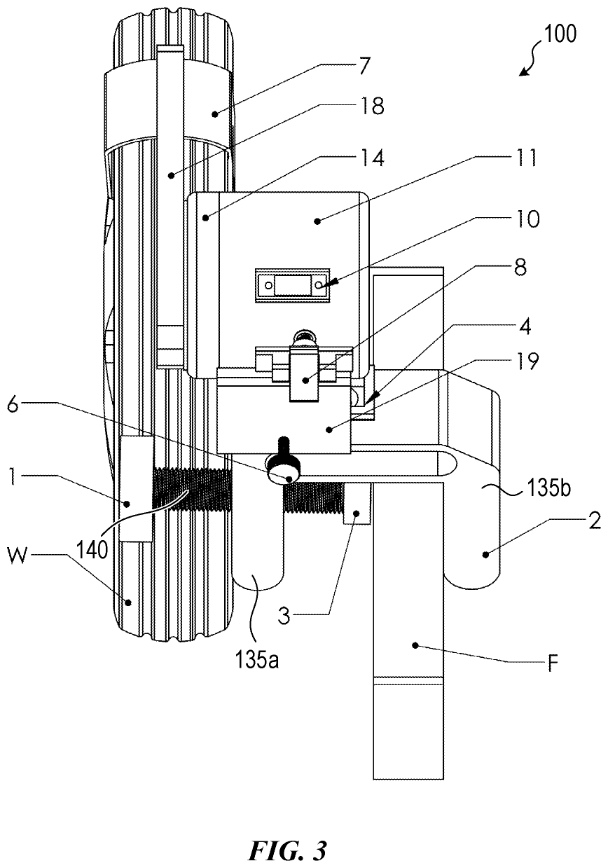

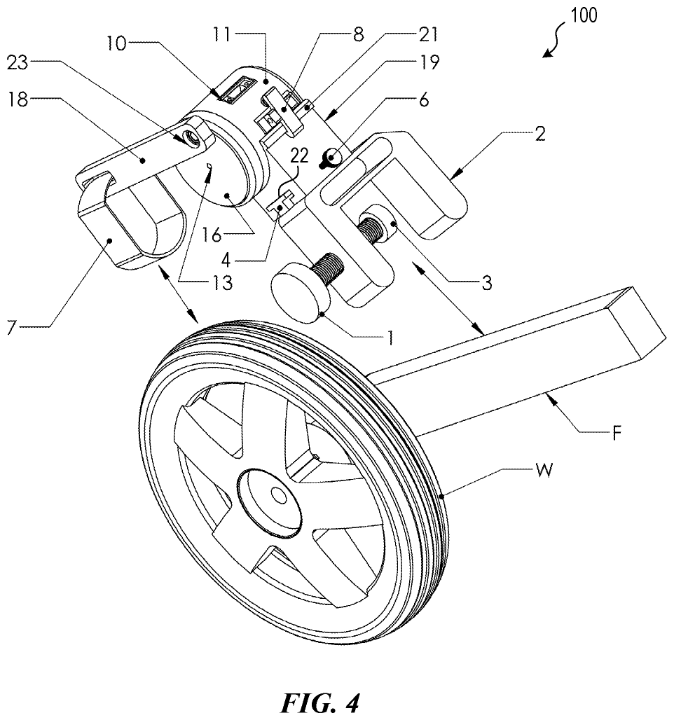

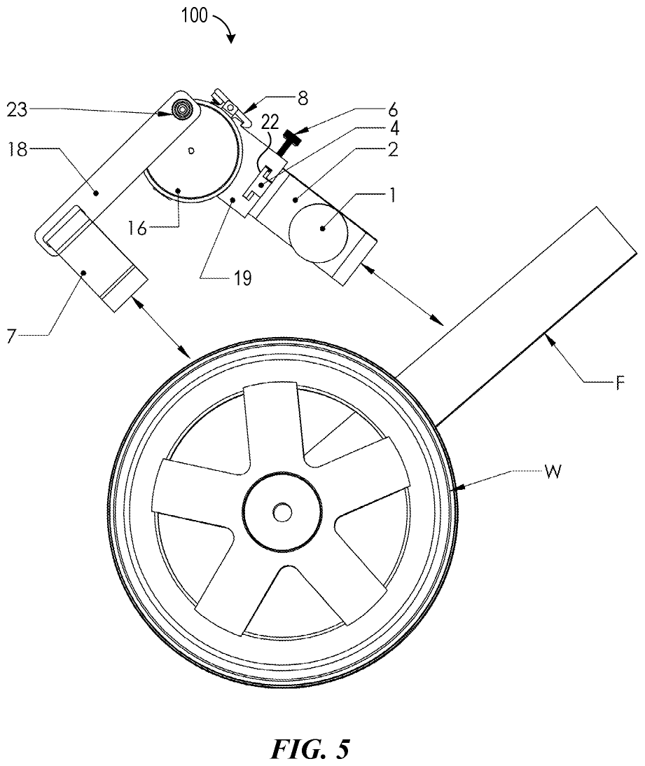

The present technology is directed to rocker systems for strollers and other wheeled carriages, and associated systems and methods. Various embodiments of the technology will now be described. The following description provides specific details for a thorough understanding and enabling description of these embodiments. One skilled in the art will understand, however, that the invention may be practiced without many of these details. Additionally, some well-known structures or functions may not be shown or described in detail to avoid unnecessarily obscuring the relevant description of the various embodiments. Accordingly, embodiments of the present technology may include additional elements or exclude some of the elements described below with reference to FIGS. 1-12, which illustrate examples of the technology.

The terminology used in this description is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all the items in the list, or (c) any combination of items in the list. Further, unless otherwise specified, terms such as “attached” or “connected” are intended to include integral connections, as well as connections between physically separate components.

FIG. 1 illustrates a partially schematic perspective view of a rocker system 100 configured in accordance with embodiments of the present technology. In FIG. 1, the rocker system 100 is attached to a portion of a wheeled carriage 110. The wheeled carriage 110 may be a stroller or another wheeled device suitable for carrying a child. Only a portion of the wheeled carriage 110 is shown in order to avoid obstructing aspects of embodiments of the present technology.

In some embodiments, the rocker system 100 may be attachable to a frame portion F of the wheeled carriage 110 (the frame portion F may connect to other parts of the wheeled carriage 110, such as a chair, a bassinet, a push handle, etc.). The wheeled carriage 110 may include one or more rotatable wheels W, which may be attached to the frame portion F, or to another suitable portion of the wheeled carriage 110. The rocker system 100 may further be attachable to one of the wheels W.

In operation, the rocker system 100 drives the wheel W back and forth (e.g., clockwise and counterclockwise) repeatedly (e.g., oscillation or reciprocation of the wheel) to move the wheeled carriage 110 in a rocking motion along a surface. In some embodiments, only one rocker system 100 may be implemented on a wheeled carriage 110, in which case only one wheel W may move, causing the wheeled carriage 110 to pivot (if the wheel W moves freely relative to another wheel) or causing the wheeled carriage 110 to reciprocate linearly. For ease of description, repeated movements of the wheeled carriage 110 resulting from the rocker system 100 may be referred to simply as rocking.

In some embodiments, the rocker system 100 may include a first attachment device 115 for attaching the rocker system 100 to the frame F, and a second attachment device 120 for attaching the rocker system 100 to the wheel W. The rocker system 100 may further include a movement mechanism 125 operatively connected to the first attachment device 115 and the second attachment device 120 to cause rocking.

The first attachment device 115 may include a clamp assembly 2, which is positioned and configured to attach to the frame F. For example, the clamp assembly 2 may include a clamp body 130 that is generally C-shaped or bracket-shaped, having two arms 135a, 135b extending from a central portion 139 and positionable on either side of the frame F. One of the arms (for example, arm 135b) may be considered a fixed jaw portion. In some embodiments, this arm (for example, 135b) may include a grip material, such as rubber, to increase friction against the frame F. The other arm (for example, arm 135a) may support a movable jaw portion 3, which may also include a grip material (such as rubber) for creating friction against the frame F. The grip materials may also protect the finish of the frame F.

The clamp assembly 2 may further include a mechanism for moving the movable jaw portion 3. In some embodiments, for example, the mechanism for moving the movable jaw portion 3 may include a knob 1 connected to a threaded rod 140, which is connected to the movable jaw portion 3. The threaded rod 140 may engage corresponding threads in the arm 135a that supports the movable jaw portion 3. Rotation of the knob 1 drives the threaded rod 140, which moves the movable jaw portion 3 toward and away from the other arm 135b to tighten, loosen, or otherwise adjust the fit of the first attachment device 115 on the frame F, similar to a C-clamp. Accordingly, in some embodiments, the first attachment device 115 may include a C-clamp. Other embodiments may include other attachment devices for attaching the rocker system 100 to the frame F or otherwise supporting the rocker system 100 on the frame F.

In some embodiments, the first attachment device 115 may further include a housing mount assembly 19, which supports the movement mechanism 125, as described in further detail below. The housing mount assembly 19 may be attached to the clamp assembly 2. In some embodiments, the housing mount assembly 19 is movable along the clamp assembly 2 (for example, movable perpendicularly or generally perpendicularly to the frame F) to further customize the fit of the rocker system 100 to the frame F and the overall wheeled carriage 110 (e.g., to adjust the fit based on the lateral distance between the wheel W and the frame F, or for other adjustments). In some embodiments, the housing mount assembly 19 may include a slot 22. The clamp assembly 2 may include a track element 4. In some embodiments, the track element 4 may be T-shaped, and the slot 22 may have a corresponding T-shape, or the track element 4 and the slot 22 may have other suitable interlocking shapes for sliding relative to each other. Accordingly, in some embodiments, the housing mount assembly 19 is movable along (e.g., laterally along) the clamp assembly 2 via the slot 22 moving about the track element 4.

To selectively lock the housing mount assembly 19 relative to the clamp assembly 2, in some embodiments, the housing mount assembly 19 may include a detent screw 6, which threads in and out of the housing mount assembly 19 (via corresponding threads in the housing mount assembly 19) to engage or disengage the track element 4 using friction or other suitable forces or engagement(s). In other embodiments, other locking mechanisms may be implemented to lock the housing mount assembly 19 along the track element 4. In some embodiments, the slot 22 and the detent screw 6 may be part of the clamp assembly 2, and the track element 4 may be part of the housing mount assembly 19.

In some embodiments, the movement mechanism 125 includes a housing 11, which may contain an actuator, such as a motor 13 (a rotational output shaft 143 of the motor 13 is visible in FIG. 1, although in some embodiments the rotational output shaft 143 may be concealed), power source, electrical wiring, and other components suitable for providing motion. The movement mechanism 125 may be releasably attachable to the housing mount assembly 19 via a housing attachment mechanism 145. For example, in some embodiments, the housing 11 carries a locking clip 8, which can pivot to engage (e.g., latch with) or disengage an edge or lip surface 21 on the housing mount assembly 19.

In some embodiments, the locking clip 8 may be spring-biased toward a configuration in which it is engaged with the lip surface 21. For example, the movement mechanism 125 may include a spring element 9 positioned between the housing 11 and the locking clip 8 (the spring element 9 is more easily viewed in other figures, which are described below). A user can push the locking clip 8 against the spring force to release the locking clip 8 from the lip surface 21. In some embodiments, the locking clip 8 pivots about a pin or screw 12, which secures the locking clip 8 to the housing 11. In some embodiments, the locking clip 8 may be carried by, and pivotable relative to, the housing mount assembly 19, while the lip surface 21 may be part of the housing 11. Other aspects of the housing attachment mechanism 145 are described in further detail below.

The movement mechanism 125 may further include a power switch 10 operatively connected to the motor and power source to turn the movement mechanism 125 on or off, or for other suitable functions. For example, the power switch 10 may include a timer to automatically turn off the movement mechanism 125 after a selected period of time or at a particular time of day. The movement mechanism 125 may further include a disk element 16, which is operatively connected to the motor 13 (e.g., via the rotational output shaft 143). In operation, the disk element 16 rotates either by oscillating back and forth or by rotating all the way around, depending in part on the configuration of the motor 13, which drives the disk element 16. In some embodiments, the motor may be configured to turn in only one direction, although other embodiments can include other configurations.

The movement mechanism 125 may further include an arm 18 for transferring linear force from the disk element 16 to the second attachment device 120. The arm 18 may be connected to the disk element 16 via a rotating attachment 23, such as a bearing. The rotating attachment 23 is positioned radially from the center of the disk element 16 (e.g., radially spaced-apart from the rotational output shaft 143) so that the disk element 16 creates force on the rotating attachment 23 that becomes linear force on the arm 18, which in turn moves the second attachment device 120. Accordingly, the disk element 16 functions as a circular crank for the arm 18, which generally reciprocates (with some pivoting motion) along pathway P. In some embodiments, the motor 13 may be—or may include—a geared motor, which can provide sufficient torque to move the disk element 16 and the arm 18 to operate the rocker system 100. Other embodiments can include other actuators or other motors.

In some embodiments, the arm 18 is a single-piece element having no joints or other discontinuities between the disk element 16 and the second attachment device 120. For example, the arm 18 may not be extendable or retractable, such that it may be a single rigid element or a rigid element formed with multiple sub-elements that do not move relative to one another to extend or retract the arm 18). This enables reliability over two-piece or adjustable arms that can fail (for example, by a joint breaking, slipping, or wearing out) or by other types of failure associated with repeated use, high stress, or other issues. A single-piece element may also simplify manufacturing. Other aspects of the movement mechanism 125 are described in further detail below.

The second attachment device 120 is attached to the arm 18 such that the arm 18 moves the second attachment device 120. The second attachment device 120 attaches the rocker system 100 to the wheel W to move the wheel W when the arm 18 moves. In some embodiments, the second attachment device 120 includes a strap 7, which may include a hook-and-loop strap (such as VELCRO®), or another strap device suitable for wrapping around a portion of the wheel W, such as around a tire or a spoke. The strap 7 is advantageously capable of tightly conforming to the wheel W to improve friction with the wheel W and for flexibly moving with the wheel W for reliable and efficient transfer of force(s) from the arm 18 to the wheel W.

The strap 7 may pass through an opening 150 in the arm 18 and loop around a portion of the wheel W. Looping around a portion of the wheel W provides more contact surface area for friction with the wheel W than a connection that does not loop around a portion of the wheel W. Although the strap 7 appears to be illustrated as a continuous loop, it is understood that the strap 7 may include a discontinuity allowing it to be opened, closed, loosened, or tightened to accommodate the portion of the wheel W. The discontinuity/attachment may include a hook-and-loop connection, snaps, latches, a buckle, or any other openable, closeable, or adjustable mechanism suitable for securing the strap to the wheel W.

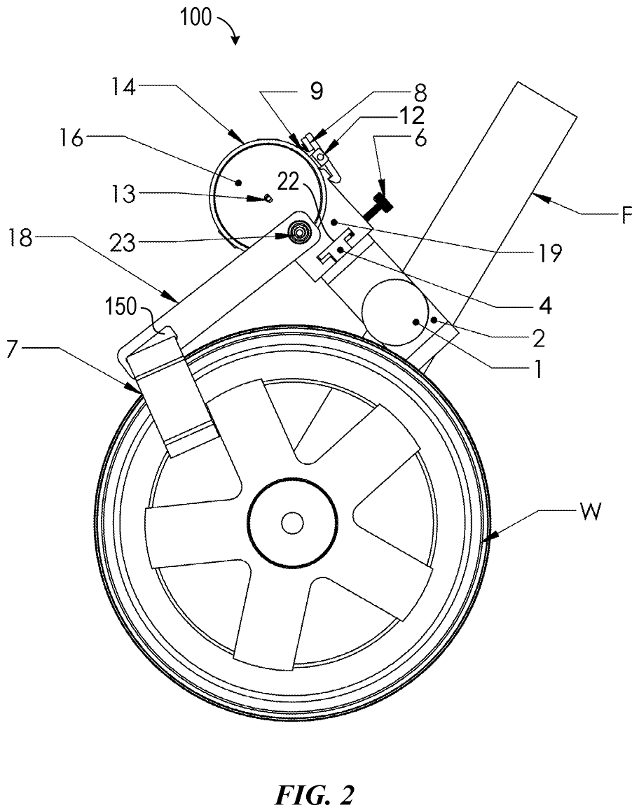

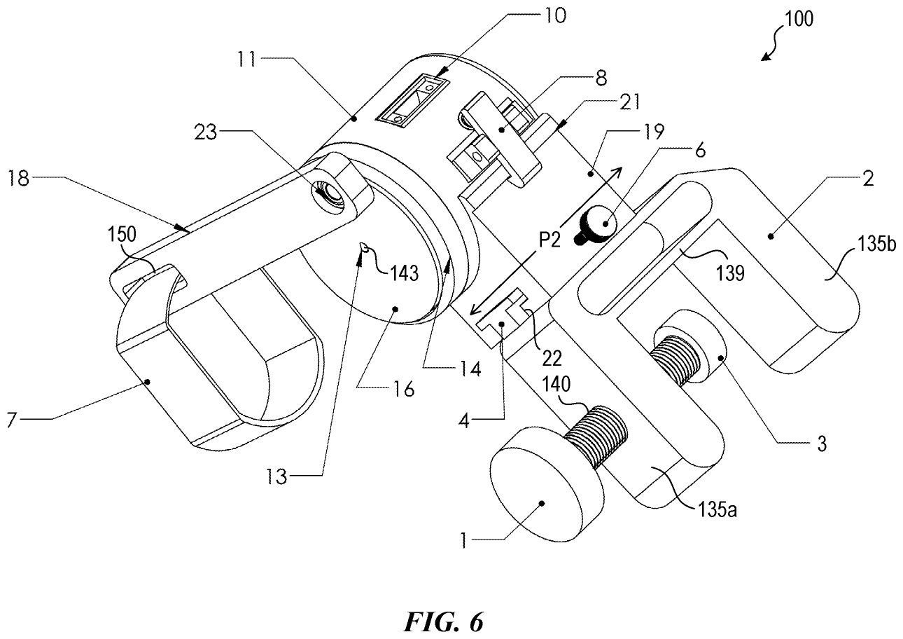

FIGS. 2-5 illustrate alternate views of the rocker system 100, as described above. FIG. 6 illustrates a partially schematic perspective view of the rocker system 100 shown in FIG. 1, without showing the frame F and the wheel W. As described in additional detail above, the track element 4 and the slot 22 facilitate translation of the housing mount assembly 19 relative to the clamp assembly 2 along pathway P2 shown in FIG. 6.

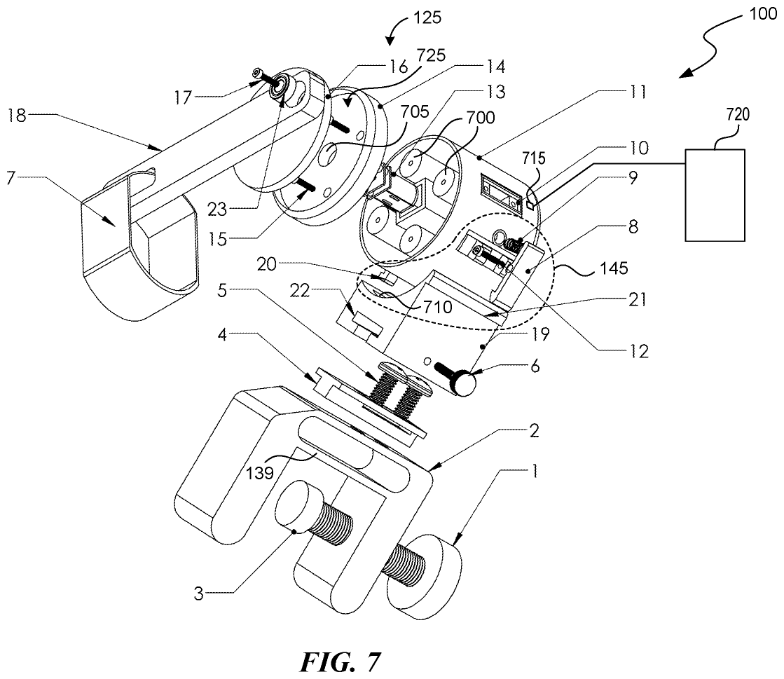

FIG. 7 illustrates a partially schematic exploded perspective view of the rocker system 100 shown in FIG. 1. In some embodiments, the track element 4 may be attached to the central portion 139 of the clamp assembly 2 via one or more fasteners 5. In some embodiments, the housing 11 may include a housing cap 14 to close off an end of the housing 11. The housing cap 14 may be secured to the housing 11 via one or more (such as four) fasteners 15 that thread into corresponding threaded elements 700 in the housing 11, or in any other suitable manner. In some embodiments, the rocker system 100 may include a connector 715 for providing an electrical connection to a power source 720, such as a battery pack or another suitable power source 720 (the connector 715 is drawn arbitrarily in FIG. 7 and may be in any suitable location or configuration). In some embodiments, the power source 720 can include a rechargeable battery bank that can be carried on the wheeled carriage 110 in a suitable manner (e.g., stored in a pocket or other area of the wheeled carriage 110). In some embodiments, the power source 720 may be internal to a portion of the rocker system 100, such as inside the housing 11, and the housing can also carry suitable connections for connecting the power source 720 to the motor 13 or the power switch 10.

The motor 13 or the rotational output shaft 143 (not visible in FIG. 7) may pass through an opening 705 in the housing cap 14 to connect to the disk element 16. The housing cap 14 contains the electronics in the housing 11 and may provide a guide or support for the motor 13. For example, in some embodiments, the housing cap 14 is indented to form a cavity region 725 to concentrically receive the disk element 16, so that the disk element 16 can remain aligned with the housing cap 14 and the housing 11 during operation, despite radial forces on the disk element 16 from the arm 18. In some embodiments, the disk element 16, the rotating attachment 23, and the arm 18 may be secured together with a disk element fastener 17, which may include a screw or similar device that threads into the disk element 16.

As explained above, the movement mechanism 125 is releasably attachable to the housing mount assembly 19 via a housing attachment mechanism 145. Specifically, the housing 11 may be releasably attachable to the housing mount assembly 19 via the housing attachment mechanism 145. In some embodiments, the housing attachment mechanism includes the locking clip 8, the spring element 9, and the lip surface 21.

In some embodiments, the housing attachment mechanism 145 may further include one or more (e.g., two) latching guides 20 (only one latching guide 20 is visible in FIG. 7). The latching guides 20 are positionable to engage corresponding latching guide receptacles 710 carried by the housing mount assembly 19. The latching guides 20 and the latching guide receptacles 710 assist the user with installing the housing 11 on the housing mount assembly 19 at the same location each time, and they provide a secure, user-releasable connection. Other embodiments may include other attachment mechanisms 145 for releasably attaching the housing 11 or other aspects of the movement mechanism 125 to the housing mount assembly 19.

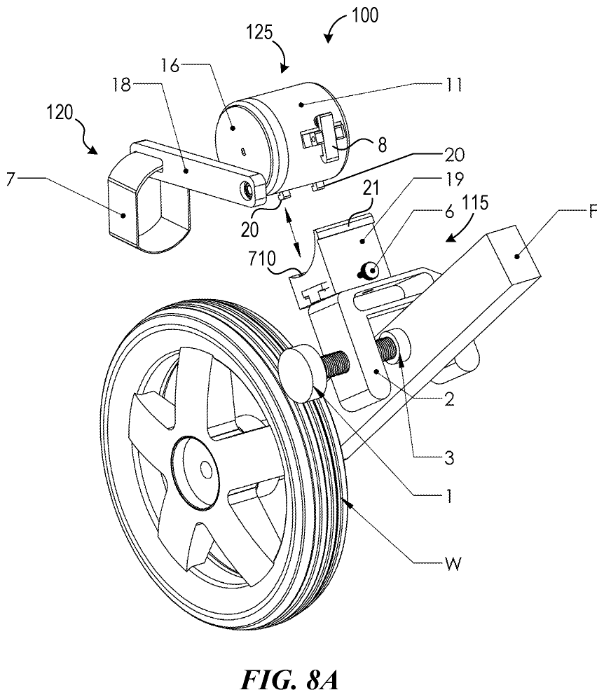

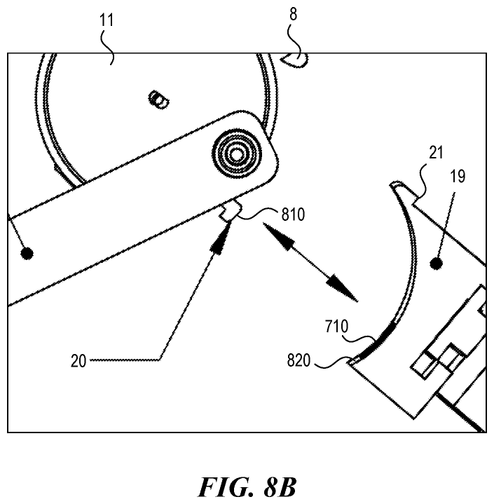

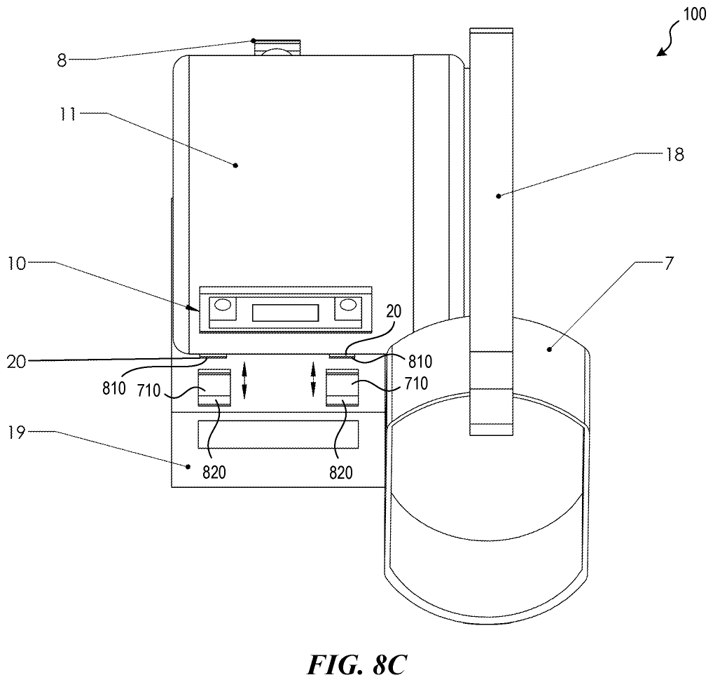

FIG. 8A illustrates a partially schematic perspective view of the rocker system 100 shown in FIG. 1, in a configuration in which the movement mechanism 125 and the second attachment device 120 are removed from the wheel W and the first attachment device 115 (e.g., removed from the housing mount assembly 19). An advantage of embodiments of the present technology is that a portion of the rocker system 100 may remain attached to the wheeled carriage 110 (e.g., the frame F) while another portion of the rocker system 100 may be removed for storage, maintenance, adjustment, or other circumstances of non-use. A user may avoid the extra complication of installing and uninstalling parts of the rocker system 100 on the frame F, saving time. The parts remaining on the frame F maintain their adjusted settings, enabling a user to simply attach and remove (e.g., click and unclick) the removable parts.

Specifically, for example, the first attachment device 115 (or components thereof, such as the housing mount assembly 19 and the clamp assembly 2) may remain attached to the wheeled carriage 110 while the movement mechanism 125 and the second attachment device 120 may be removable. In FIG. 8A, the locking clip 8 has been released from the lip surface 21 to unlock the housing 11 from the housing mount assembly 19. In addition, the latching guides 20 (there may be one, two, or any other suitable number of latching guides 20) have been removed from within the latching guide receptacles 710 (the number of latching guide receptacles 710 may correspond to the number of latching guides 20, or a single latching guide receptacle 710 may receive multiple latching guides 20). To assemble the rocker system 100, the latching guides 20 are placed in the latching guide receptacles 710, which engage the latching guides 20 (described in additional detail below), and the locking clip 8 is clicked over the lip surface 21. Disassembly is the reverse (i.e., releasing the locking clip 8 and the latching guides 20).

FIG. 8B illustrates a detailed side view of a portion of the rocker system 100 in the configuration shown in FIG. 8A. FIG. 8C illustrates a top view of a portion of the rocker system 100 in the configuration shown in FIG. 8A (in FIG. 8C, some components of the technology have been omitted for clarity). With reference to FIGS. 8B and 8C, in some embodiments, each latching guide 20 may include a generally backward-L-shaped or hook-shaped element having an extension portion 810 positioned to enter the latching guide receptacle 710 and engage a lip 820 on the housing mount assembly 19 adjacent to the latching guide receptacle 710, to releasably remain in the latching guide receptacle 710. The latching guides 20 may hook onto the corresponding lips 820.

In some embodiments, the housing 11 and the housing mount assembly 19 may have corresponding or complementary shapes or profiles to facilitate nesting the housing 11 and the housing mount assembly 19. For example, in some embodiments, the housing 11 can be at least partially cylindrical or entirely cylindrical, and the housing mount assembly 19 can include a correspondingly shaped or complementary-shaped (e.g., round or partially cylinder-shaped) cutout or cavity for receiving the housing mount assembly 19. The cylindrical arrangement may facilitate attachment and separation of the housing mount assembly 19 and the housing 11 by allowing the housing 11 to rotate in the cylindrical cutout or cavity of the housing mount assembly 19 to slip the latching guides 20 into the latching guide receptacles 710, and then the locking clip 8 clicks onto the lip surface 21.

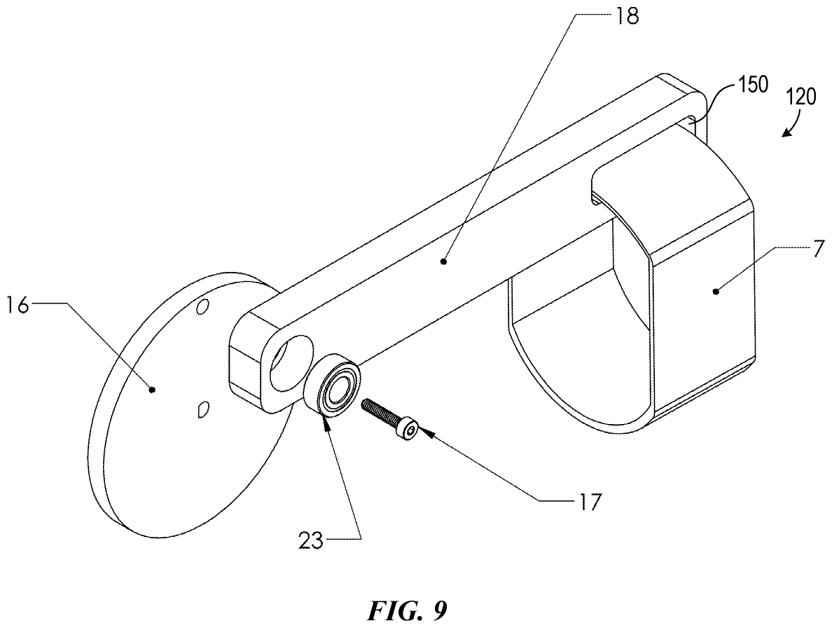

FIG. 9 illustrates a partially schematic exploded perspective view of the second attachment device 120 (e.g., the strap 7) and a portion of the movement mechanism 125. As explained in further detail above, the disk element fastener 17 may attach the rotating element 23 and the arm 18 to the disk element 16 in a manner that facilitates pivoting of the arm 18 relative to the disk element 16 about the disk element fastener 17. In other embodiments, other connections may be implemented to pivotably or rotatably connect the arm 18 to the disk element 16. The offset of the disk element fastener 17 from the center of the disk element 16 facilitates the oscillating or rocking motion.

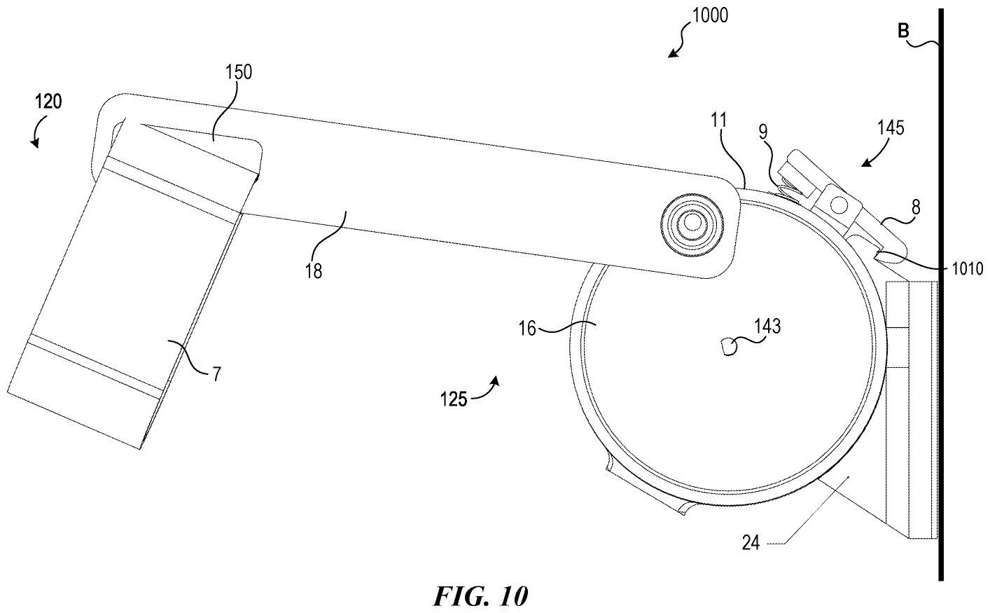

FIG. 10 illustrates a side perspective view of a rocker system 1000 configured in accordance with another embodiment of the present technology. In some embodiments, the rocker system 1000 may include a wall mount 24 and the movement mechanism 125. In FIG. 10, the movement mechanism 125 is attached to the wall mount 24. The wall mount 24 may be temporarily or permanently attached to a wall or other fixed object B (hereinafter referred to as a “wall” B). The wall mount 24 may receive and support the movement mechanism 125 in a manner similar to the connection between the movement mechanism 125 and the housing mount assembly 19. Accordingly, the wall mount 24 forms a first attachment device, the second attachment device 120 may attach to a wheel W, and the movement mechanism 125 can move the wheel W relative to the wall B. Because the wall mount 24 may be in a fixed location, the rocker system 1000 enables a wheeled carriage 110 to be moved relative to the wall B in a similar manner as described above for the rocker system 100, while also keeping the wheeled carriage 110 from moving away from the general location of the rocker system 1000. Although the wall mount 24 is called a “wall mount,” in some embodiments, it can attach to any fixed object or any other suitable object, such as a door, a post, a chair, or other stable objects typically found in a home or business.

The movement mechanism 125 can be attached to the wall mount 24 or the housing mount assembly 19 depending on the user's desired implementation (e.g., if a user is at home, perhaps the wall mount 24 is more appropriate, while if a user is away from home or outdoors, perhaps the housing mount assembly 19 is more appropriate). Accordingly, a system configured in accordance with embodiments of the present technology can include one more of the movement mechanism 125, the wall mount 24, the first attachment device 115, or a power source 720.

In some embodiments, the movement mechanism 125 can include some or all aspects of the housing attachment mechanism 145 described above to attach the movement mechanism 125 to the wall mount 24 (thus, the housing attachment mechanism 145 may also be described as a wall mount attachment mechanism 145). For example, in some embodiments, the housing attachment mechanism 145 can include the spring-biased locking clip 8, which can engage or disengage an edge or lip surface 1010 on the wall mount 24 (in a manner similar to engagement between the lip surface 21 on the housing mount assembly 19 in FIGS. 1 and 6, for example).

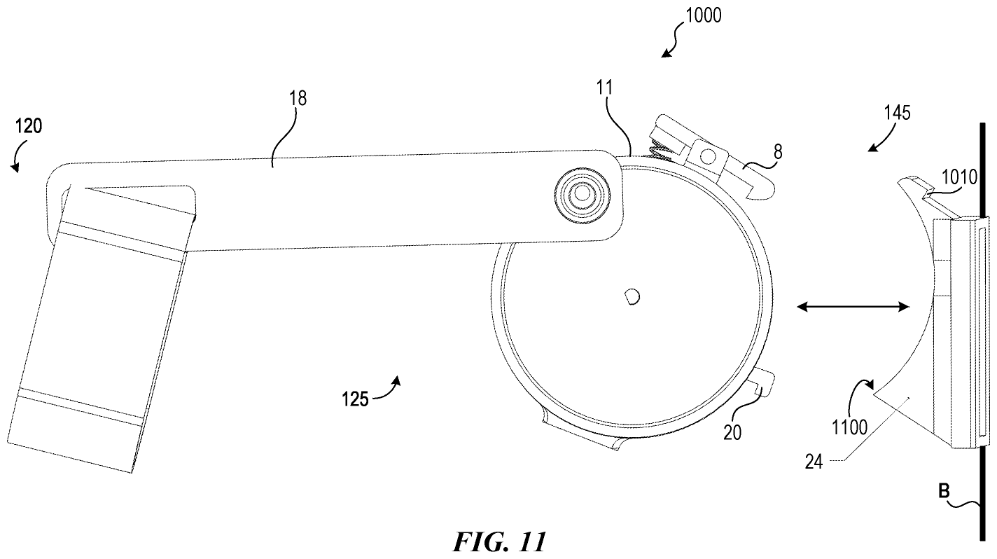

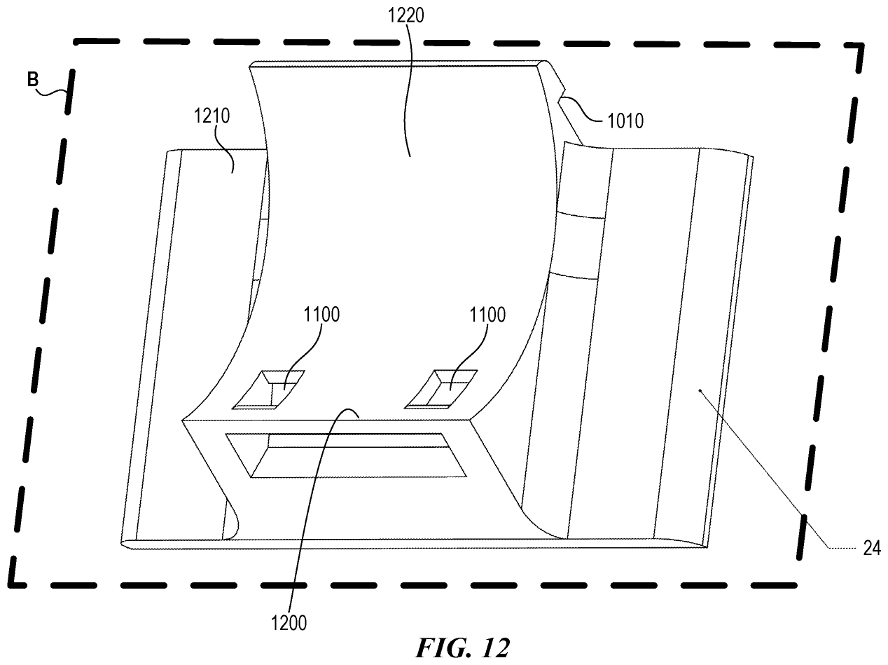

FIG. 11 illustrates a partially schematic side perspective view of the rocker system 1000 shown in FIG. 10, in a configuration in which the movement mechanism 125 is separated from the wall mount 24. As explained above, in some embodiments, the housing attachment mechanism 145 may include the latching guides 20 (only one latching guide 20 is visible in FIG. 11), which are positionable to engage corresponding latching guide receptacles 1100 in the wall mount 24. The latching guide receptacles 1100 are not visible in FIG. 11, but are visible in FIG. 12, which is described below. In some embodiments, the latching guide receptacles 1100 function similarly to the latching guide receptacles 710 described above with regard to FIGS. 7, 8A, and 8B, for example. Accordingly, the latching guides 20 and the latching guide receptacles 1100 provide a secure, user-releasable connection between the housing 11 and the wall mount 24. Other embodiments may include other attachment mechanisms 145 for releasably attaching the housing 11 or other aspects of the movement mechanism 125 to the wall mount 24.

To attach the rocker system 1000 to the wall mount 24, the latching guides 20 are placed in the latching guide receptacles 1100, which engage the latching guides 20, and the locking clip 8 is clicked over the lip surface 1010. Disassembly is the reverse (i.e., releasing the locking clip 8 and the latching guides 20).

FIG. 12 illustrates a perspective view of the wall mount 24 shown in FIGS. 10 and 11. Similar to the housing mount assembly 19, the wall mount 24 may include the latching guide receptacles 1100 (which may be similar to the latching guide receptacles 710 described above) and a lip 1200 (which may be similar to the lip 820 described above) for facilitating the releasable connection between the movement mechanism 125 and the wall mount 24 via the latching guides 20.

In some embodiments, the housing 11 and the wall mount 24 may have corresponding or complementary shapes or profiles to facilitate nesting the housing 11 and the wall mount 24, in a similar manner as described above for the housing 11 and the housing mount assembly 19 (e.g., corresponding or complementary rounded or cylindrical shapes or other suitable nestable shapes that may allow the housing 11 to rotate relative to the wall mount 24 during attachment to slip the latching guides 20 into the latching guide receptacles 1100, and then to allow the locking clip 8 to click onto the lip surface 1010).

In some embodiments, the wall mount 24 may include a base portion 1210 and an attachment portion 1220 integral with, or attached to, the base portion 1210. The attachment portion 1220 may include the latching guide receptacles 1100, the lip surface 1010, and the lip 1200. The base portion 1210 may extend generally laterally away from the attachment portion 1220 to form a wide distribution of forces on the wall B. The base portion 1210 may be attached to the wall B using any suitable mounting devices, such as fasteners, adhesive, tape, or other attachments or connections.

Advantages of embodiments of the present technology include, for example: portability (the rocker systems 100, 1000 are generally small, and their separable portions are also small); adaptability (the clamp assembly 2 adapts to frames of various sizes, the track element 4 provides additional lateral adjustability relative to the clamp assembly 2, the strap 7 facilitates connection with various wheel shapes and sizes, and the wall mount 24 provides an alternative mount location such as a wall B); ease of installation and removal (e.g., a user can separate the movement mechanism 125 and the second attachment device 120 from the housing mount assembly 19, leaving the first attachment device 115 on the wheeled carriage 110, which allows the first attachment device 115 to stay in an adjusted configuration relative to the wheeled carriage 110, and allows a user to only need to manage/store a small portion of the rocker system 100 when it is not in use; or a user can separate the movement mechanism 125 and the second attachment device 120 from the wall mount 24, leaving the wall mount 24 attached to the wall B); and reliability (the arm 18 is a single non-adjustable piece therefore it does not have the failure point a two-part arm would have).

Several additional embodiments of the present technology are set forth in the following examples. In some embodiments, the examples may be combined with one another. Some embodiments may omit one or more aspects of the examples.
1. A rocker system comprising a first attachment device for attaching the rocker system to a frame, a second attachment device for attaching the rocker system to a wheel, and a movement mechanism operatively connecting the first attachment device to the second attachment device, wherein the movement mechanism causes the second attachment device to move the wheel back and forth, and wherein the movement mechanism is removable from the first attachment device.
2. The rocker system of example 1, wherein the first attachment device comprises a clamp assembly positionable to clamp onto the frame, and a housing mount assembly supported on and movable relative to the clamp assembly.
3. The rocker system of example 2, wherein the housing mount assembly is movable relative to the clamp assembly via a track element in a slot.
4. The rocker system of example 3, further comprising a detent element (such as a detent screw) for locking the housing mount assembly relative to the clamp assembly.
5. The rocker system of any one of examples 1-4, wherein the second attachment device comprises a strap positionable around the wheel.
6. The rocker system of example 5, wherein the strap comprises a hook-and-loop fastener.
7. The rocker system of any one of examples 1-6, wherein the movement mechanism comprises:
a motor operatively connected to a disk element to rotate the disk element; and
an arm connected to the disk element and positioned to move when the motor rotates the disk element.
8. The rocker system of example 7, wherein the arm carries or is connected to the second attachment device and moves the second attachment device to move the wheel.
9. The rocker system of example 7 or example 8, wherein the arm is a single unitary element between the second attachment device and the disk element, wherein the arm is not extendable or retractable via a telescoping joint or other kind of joint.
10. The rocker system of any one of examples 7-9, wherein the motor comprises a geared motor.
11. The rocker system of example 1, wherein:
the movement mechanism comprises a housing;
the first attachment device comprises a housing mount assembly;
the housing carries a pivotable locking clip, which is optionally spring-biased;
the housing mount assembly has a lip surface positioned to engage with the pivotable locking clip;
the housing carries one or more latching guides (which may be L-shaped or hook-shaped or other suitable shapes); and
the housing mount assembly comprises one or more latching guide receptacles, each latching guide receptacle comprising or adjacent to a lip;
wherein the each of the one or more latching guide receptacles receives a corresponding latching guide of the one or more latching guides, and wherein each lip engages a latching guide.
12. A wheeled carriage comprising the rocker system of any one of examples 1-11.
13. The wheeled carriage of example 12, wherein the wheeled carriage is a stroller.
14. A method of connecting a rocker system to a wheeled carriage and operating the rocker system, the method comprising attaching a first attachment device to a frame of the wheeled carriage, attaching a second attachment device to a wheel of the wheeled carriage, releasably connecting a movement mechanism to the first attachment device, and operating a motor to move the second attachment device relative to the first attachment device, wherein the second attachment device is connected to, and driven by, the movement mechanism.
15. The method of example 14, wherein the first attachment device comprises a housing mount assembly that is connectable to the movement mechanism, the first attachment device comprises a clamp assembly that is attachable to the frame, the housing mount assembly is slidable or otherwise movable relative to the clamp assembly, and wherein the method comprises moving the housing mount assembly relative to the clamp assembly to adjust the rocker system.
16. A rocker system comprising a first attachment device for attaching the rocker system to an object, a second attachment device for attaching the rocker system to a wheel, and a movement mechanism operatively connecting the first attachment device to the second attachment device, wherein the movement mechanism causes the second attachment device to move the wheel back and forth, and wherein the movement mechanism is removable from the first attachment device.
17. The rocker system of example 16, wherein the object is a fixed object such as a wall.
18. The rocker system of example 16, wherein the first attachment device comprises a wall mount.
19. The rocker system of any one of examples 16-18, wherein the second attachment device comprises a strap positionable around the wheel.
20. The rocker system of example 19, wherein the strap comprises a hook-and-loop fastener.
21. The rocker system of any one of examples 16-20, wherein the movement mechanism comprises:
a motor operatively connected to a disk element to rotate the disk element; and
an arm connected to the disk element and positioned to move when the motor rotates the disk element.
22. The rocker system of example 21, wherein the arm carries or is connected to the second attachment device and moves the second attachment device to move the wheel.
23. The rocker system of example 21 or example 22, wherein the arm is a single unitary element between the second attachment device and the disk element, wherein the arm is not extendable or retractable via a telescoping joint or other kind of joint.
24. The rocker system of any one of examples 21-23, wherein the motor comprises a geared motor.
25. The rocker system of example 16, wherein:
the movement mechanism comprises a housing;
the first attachment device comprises a wall mount;
the housing carries a pivotable locking clip, which is optionally spring-biased;
the wall mount has a lip surface positioned to engage with the pivotable locking clip;
the housing carries one or more latching guides (which may be L-shaped or hook-shaped or other suitable shapes); and
the wall mount comprises one or more latching guide receptacles, each latching guide receptacle comprising or adjacent to a lip;
wherein the each of the one or more latching guide receptacles receives a corresponding latching guide of the one or more latching guides, and wherein each lip engages a latching guide.
26. A method of connecting a rocker system to a fixed object (such as a wall) and operating the rocker system, the method comprising attaching a first attachment device to the fixed object, attaching a second attachment device to a wheel of a wheeled carriage, releasably connecting a movement mechanism to the first attachment device, and operating a motor to move the second attachment device relative to the first attachment device, wherein the second attachment device is connected to, and driven by, the movement mechanism.

From the foregoing, it will be appreciated that specific embodiments of the presently disclosed technology have been described herein for purposes of illustration, but that various modifications may be made without deviating from the scope of the technology.

Certain aspects of the technology described in the context of particular embodiments may be combined or eliminated in other embodiments. Further, while advantages associated with certain embodiments of the presently disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

Numerical adjectives including “first” and “second,” or the like, as used in the present disclosure, do not convey hierarchy or specific features or functions. Rather, such numerical adjectives are intended to aid the reader in distinguishing between elements which may have similar nomenclature, but which may differ in position, orientation, function, or structure. Accordingly, such numerical adjectives may be used differently in the claims. To the extent any materials incorporated herein by reference conflict with the present disclosure, the present disclosure controls.

What is claimed is:

1. A wheeled carriage system comprising a wheeled carriage and a rocker system for oscillating the wheeled carriage, the wheeled carriage comprising a frame and a wheel rotatably attached to the frame, the rocker system comprising:
a first attachment device for attaching the rocker system to the frame,
a second attachment device for attaching the rocker system to the wheel; and
a movement mechanism operatively connecting the first attachment device to the second attachment device, wherein movement of the movement mechanism causes the second attachment device to move the wheel back and forth, and wherein the movement mechanism is removable from the first attachment device.

2. The wheeled carriage system of claim 1, wherein the first attachment device comprises a clamp assembly positionable to clamp onto the frame, and a housing mount assembly supported on and movable relative to the clamp assembly.

3. The wheeled carriage system of claim 2, wherein the housing mount assembly is movable relative to the clamp assembly via a track element.

4. The wheeled carriage system of claim 3, further comprising a detent element for locking the housing mount assembly relative to the clamp assembly.

5. The wheeled carriage system of claim 1, wherein the second attachment device comprises a strap positionable around the wheel.

6. The wheeled carriage system of claim 5, wherein the strap comprises a hook-and-loop fastener.

7. The wheeled carriage system of claim 1, wherein the movement mechanism comprises:
an actuator operatively connected to a disk element to rotate the disk element; and
an arm connected to the disk element and positioned to move when the actuator rotates the disk element.

8. The wheeled carriage system of claim 7, wherein the arm carries or is connected to the second attachment device and moves the second attachment device to move the wheel.

9. The wheeled carriage system of claim 7, wherein the arm is a single unitary element between the second attachment device and the disk element, wherein the arm is not extendable or retractable via a telescoping joint or other kind of joint.

10. The wheeled carriage system of claim 7, wherein the actuator comprises a geared motor.

11. The wheeled carriage system of claim 1, wherein:
the movement mechanism comprises a housing;
the first attachment device comprises a housing mount assembly;
the housing carries a pivotable locking clip;
the housing mount assembly has an edge positionable to engage with the pivotable locking clip;
the housing carries one or more latching guides; and
the housing mount assembly comprises one or more latching guide receptacles, each latching guide receptacle comprising a lip;
wherein each of the one or more latching guide receptacles receives a corresponding latching guide of the one or more latching guides, and wherein each lip engages a latching guide.

12. The wheeled carriage system of claim 1, further comprising a third attachment device for attaching the rocker system to a fixed structure.

13. A rocker system for a wheeled carriage, the rocker system comprising:
a first attachment device for attaching the rocker system to an object;
a second attachment device for attaching the rocker system to a wheel; and
a movement mechanism operatively connecting the first attachment device to the second attachment device, wherein the movement mechanism causes the second attachment device to move the wheel back and forth, and wherein the movement mechanism is removable from the first attachment device.

14. The rocker system of claim 13, wherein the object is a fixed structure, wherein the fixed structure is at least one of a door, a wall, or a chair.

15. The rocker system of claim 13, wherein the object is a frame of a wheeled carriage carrying the wheel.

16. The rocker system of claim 13, wherein the second attachment device comprises a strap positionable around the wheel.

17. The rocker system of claim 13, wherein the movement mechanism comprises:
a motor operatively connected to a disk element to rotate the disk element; and
an arm connected to the disk element and positioned to move when the motor rotates the disk element.

18. The rocker system of claim 17, wherein the arm carries or is connected to the second attachment device and is movable to move the second attachment device.

19. The rocker system of claim 17, wherein the arm is a single unitary element between the second attachment device and the disk element, wherein the arm is neither extendable nor retractable.

20. The rocker system of claim 13, wherein:
the movement mechanism comprises a housing;
the first attachment device comprises a wall mount;
the housing carries a pivotable locking clip;
the wall mount has an edge positioned to engage with the pivotable locking clip;
the housing carries one or more latching guides; and
the wall mount comprises one or more latching guide receptacles, each latching guide receptacle comprising a lip;
wherein each of the one or more latching guide receptacles receives a corresponding latching guide of the one or more latching guides, and wherein each lip engages a latching guide.

21. A rocker system for a stroller, the rocker system comprising:
a first attachment device configured to attach the rocker system to a frame of the stroller, wherein the first attachment device comprises a clamp assembly and a housing mount assembly supported on, and movable relative to, the clamp assembly;
a second attachment device configured to attach the rocker system to a wheel of the stroller, the second attachment device comprising a strap positionable around the wheel; and
a movement mechanism operatively connecting the first attachment device to the second attachment device, wherein the movement mechanism causes the second attachment device to move the wheel back and forth relative to the first attachment device;
wherein:
(a) the movement mechanism comprises a housing, a rigid arm connectable to the second attachment device, and an actuator positionable to move the arm and the second attachment device relative to the first attachment device, wherein the rigid arm is neither extendable nor retractable; and
(b) the housing is releasably attachable to the housing mount assembly.

22. The rocker system of claim 21, further comprising a third attachment device configured to attach the movement mechanism to a wall, wherein the housing is releasably attachable to the third attachment device.
